(19) United States
(12) Patent Application Publication
(10) Pub. No.: US 2006/0039163 A1
(43) Pub. Date: Feb. 23, 2006

(54) Supporting member for a display device, backlight assembly having the same and display device having the same

(75) Inventor: Su-Young Yun, Cheonan-si (KR)

Correspondence Address: F. CHAU & ASSOCIATES, LLC, 130 WOODBURY ROAD, WOODBURY, NY, 11797, US

(73) Assignee: Samsung Electronics Co., Ltd.

(21) Appl. No.: 11/206,235

(22) Filed: Aug. 17, 2005

(30) Foreign Application Priority Data
Aug. 21, 2004 (KR) 2004-66153
Mar. 23, 2005 (KR) 2005-24207

(51) Int. Cl. F21V 7/04

(52) U.S. Cl. 362/600

(57) ABSTRACT

A supporting member that is combined with a receiving container having a throughhole to support at least one lamp generating light includes a base substrate, a lamp-fixing part and a combination part. The lamp-fixing part is formed on an upper surface of the base substrate to fix the lamp. The combination part is formed on a lower surface of the base substrate. The combination part is inserted through the throughhole and slides in one direction to be combined with a bottom plate of the receiving container. The supporting member may further include a plurality of combination parts spaced apart from each other with respect to a longitudinal central line of the base substrate. Thus, the thickness of the supporting member externally protruded from the receiving container may be reduced, and leakage of the light generated from the lamp may be prevented.

### CROSS REFERENCE TO RELATED APPLICATIONS

This application claims priority from Korean Patent Application No. 2004-66153 filed on Aug. 21, 2004 and Korean Patent Application No. 2005-24207 filed on Mar. 23, 2005, the contents of which are herein incorporated by reference in their entireties.

### BACKGROUND OF THE INVENTION

1. Technical Field

The present disclosure relates to a supporting member for a display device, a backlight assembly having the supporting member and a display device having the supporting member. More particularly, the present disclosure relates to a supporting member for a display device capable of reducing a thickness of the supporting member and improving optical characteristics, a backlight assembly having the supporting member and a display device having the supporting member.

2. Discussion of the Related Art

A liquid crystal display (LCD) device displays an image using electrical and optical characteristics of liquid crystal installed in the LCD device. The LCD device has a small volume and is lightweight in comparison with a cathode ray tube (CRT). Thus, the LCD device has been used for devices such as portable computers, communication devices, television receiver sets.

The LCD device includes a liquid crystal controlling unit that controls liquid crystal, and a light providing unit that provides the liquid crystal with light. For example, the LCD device includes a cold cathode fluorescent lamp (CCFL) serving as the light providing unit.

The CCFL, for example, has various shapes such as a rod shape, and a U-shape. The CCFL can be combined with and fixed to a receiving container. The light providing unit of the LCD device can include a supporting member so as to fix the CCFL to the receiving container. The lamp, the receiving container and the supporting member constitute the light providing unit, that is, a backlight assembly.

A conventional supporting member is combined with the receiving container using a hook. In other words, the hook of the supporting member is inserted into a hole that is formed on the receiving container, and hooked at a portion of the receiving container, which is adjacent to the hole, so that the supporting member is fastened to the receiving container. However, when the conventional supporting member is combined with the receiving container, a gap is formed between the hook and the receiving container. Thus, after the conventional supporting member is combined with the receiving container, the gap remains between the hook and the receiving container.

The formation of the gap between the hook and the receiving container may result in impurities flowing into the gap, generation of a rattle noise due to vibration of the conventional supporting member caused by, for example, a frequency of a speaker employed in an LCD device having the backlight assembly, and leakage of light that is generated from a CCFL employed in the backlight assembly.

Therefore, optical characteristics of the back light assembly and display quality of the LCD device may be deteriorated when using the conventional supporting member.

### SUMMARY OF THE INVENTION

Embodiments of the present invention provide a supporting member for a display device, which is capable of decreasing a gap between a supporting member and a receiving container, a backlight assembly having the above-mentioned supporting member, and a display device having the above-mentioned supporting member.

In an embodiment of the present invention, a supporting member is combined with a receiving container having a throughhole to support at least one lamp generating light. The supporting member includes a base substrate, a lamp-fixing part and a combination part. The lamp-fixing part is formed on an upper surface of the base substrate to fix the lamp. The combination part is formed on a lower surface of the base substrate. The combination part is inserted through the throughhole and slides in one direction to be combined with a bottom plate of the receiving container. The supporting member may further include a plurality of combination parts spaced apart from each other with respect to a longitudinal central line of the base substrate.

In another embodiment of the present invention, a supporting member for a display device includes a base substrate, a lamp-fixing part, a supporting part and at least two combination parts. The lamp-fixing part is upwardly protruded from the base substrate to fix at least one lamp generating a light. The supporting part is upwardly protruded from the base substrate to support an optical member that improves optical characteristics of the light. The combination parts are downwardly protruded from the base substrate. The combination parts are spaced apart from each other with respect to a longitudinal central line of the base substrate.

In still another embodiment of the present invention, a backlight assembly includes a lamp, a receiving container and a supporting member. The lamp generates light. The receiving container receives the lamp, and includes a bottom plate through which a throughhole is formed. The supporting member includes a base substrate, a lamp-fixing part formed on an upper surface of the base substrate to fix the lamp and a combination part formed on a lower surface of the base substrate. The combination part is inserted through the throughhole and slides in one direction to be combined with a bottom plate of the receiving container.

In still another embodiment of the present invention, a display device includes a backlight assembly and a display panel. The backlight assembly includes a lamp, a receiving container and a supporting member. The lamp generates light. The receiving container receives the lamp, and includes a bottom plate through which a throughhole is formed. The supporting member includes a base substrate, a lamp-fixing part formed on an upper surface of the base substrate to fix the lamp and a combination part formed on a lower surface of the base substrate. The combination part is inserted through the throughhole and slides in one direction to be combined with a bottom plate of the receiving container. The display panel displays an image using the light from the backlight assembly.

In still another embodiment of the present invention, a display device includes a display panel, a lamp, an optical member, a receiving container and a supporting member. The display panel displays an image using light. The lamp generates the light. The optical member improves optical characteristics of the light from the lamp. The receiving container receives the lamp and has a throughhole. The supporting member includes a base substrate, a lamp-fixing part protruded from the base substrate to fix at least one lamp generating a light, a supporting part protruded from the base substrate to support the optical member and at least two combination parts protruded from the base substrate to be combined with the receiving container. The combination parts are spaced apart from each other with respect to a longitudinal central line of the base substrate.

The supporting member prevents a gap from being formed between the supporting member and a receiving container, so that impurities may not flow into a space between the supporting member and the receiving container. A rattle noise of the supporting member may be prevented. The rattle noise may be due to, for example, vibration corresponding to a frequency of a speaker employed in an LCD device having the supporting member. Leakage of light that is generated from a lamp employed in a backlight assembly having the supporting member may be also prevented.

Furthermore, drift of the supporting member may be prevented, and a secure combination of the supporting member with the receiving container may be obtained.

### BRIEF DESCRIPTION OF THE DRAWINGS

Preferred embodiments of the present invention can be understood in more detail from the following descriptions taken in conjunction with the accompanying drawings in which:

FIG. 1 is an exploded perspective view illustrating a backlight assembly according to an embodiment of the present invention;

FIG. 2 is a perspective view illustrating a supporting member and lamps combined with the supporting member according to an embodiment of the present invention;

FIG. 3 is a front view illustrating a supporting member and a receiving container combined with the supporting member according to an embodiment of the present invention;

FIGS. 4A and 4B are partially cut-out front views illustrating a combination of a supporting member with a receiving container according to an embodiment of the present invention;

FIGS. 5A and 5B are partially cut-out perspective views illustrating a combination of a supporting member with a receiving container according to an embodiment of the present invention;

FIG. 6 is an exploded perspective view illustrating a backlight assembly according to an embodiment of the present invention;

FIG. 7 is a front view illustrating a supporting member according to an embodiment of the present invention;

FIG. 8 is a bottom view illustrating a supporting member according to an embodiment of the present invention;

FIG. 9 is a partially cut-out exploded perspective view illustrating a combination of a supporting member with lamps, a reflective sheet and a receiving container according to an embodiment of the present invention;

FIG. 10 is a cross-sectional view taken along a line I-I′ in FIG. 6;

FIG. 11 is an enlarged cross-sectional view illustrating a portion ‘A’ in FIG. 10; and

FIG. 12 is an exploded perspective view illustrating a liquid crystal display device according to an embodiment of the present invention.

### DETAILED DESCRIPTION OF THE EXEMPLARY EMBODIMENTS

Exemplary embodiments of the present invention now will be described more fully hereinafter in more detail with reference to the accompanying drawings, in which embodiments of the invention are shown. This invention may, however, be embodied in many different forms and should not be construed as limited to the embodiments set forth herein.

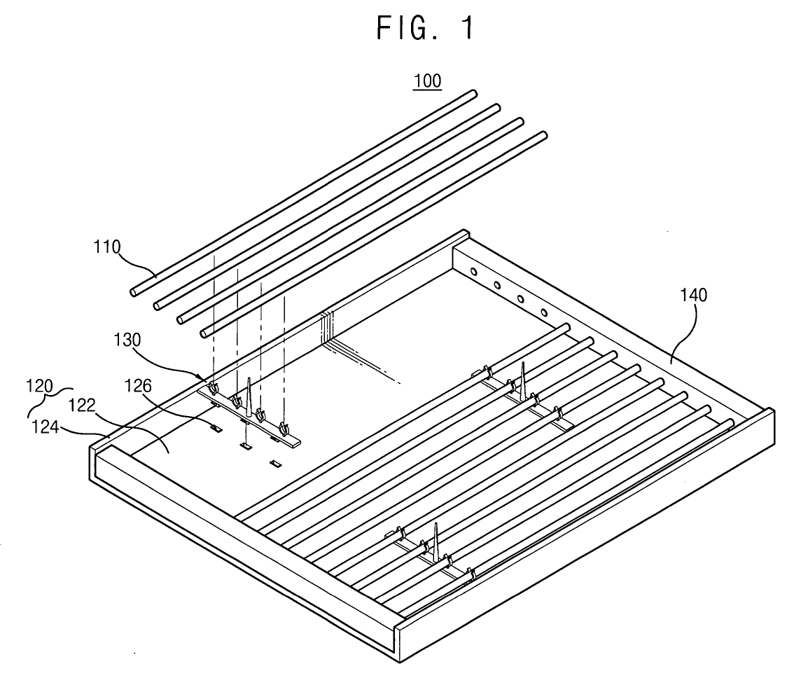

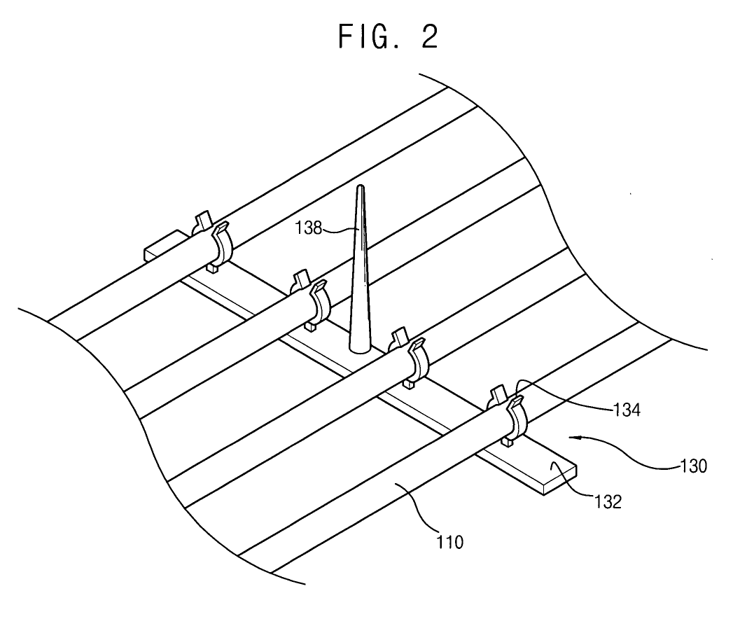

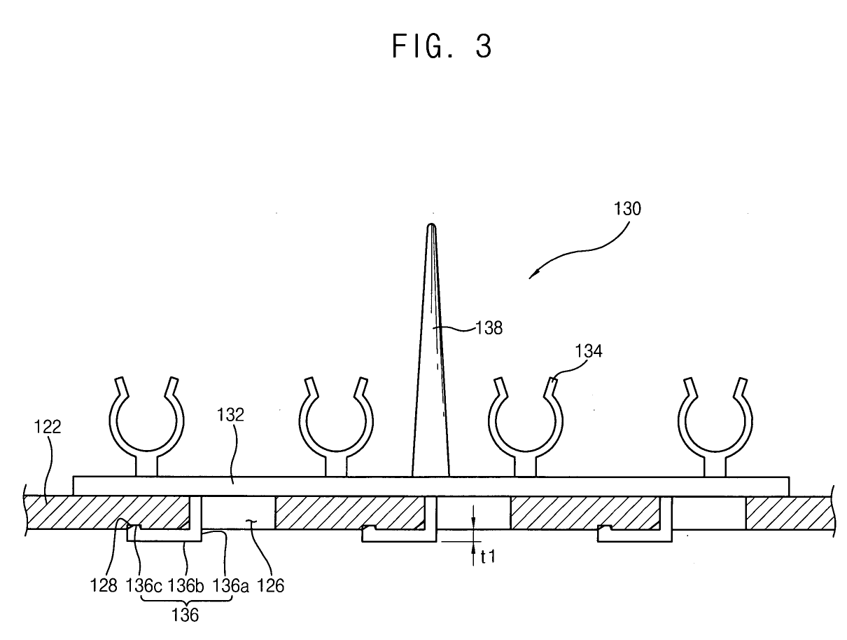

FIG. 1 is an exploded perspective view illustrating a backlight assembly according to an embodiment of the present invention. FIG. 2 is a perspective view illustrating a supporting member and lamps combined with the supporting member. FIG. 3 is a front view illustrating a supporting member and a receiving container combined with the supporting member.

Referring to FIGS. 1 through 3, a backlight assembly 100 includes a plurality of lamps 110, a receiving container 120 and a supporting member 130.

Each of the lamps 110 includes a pair of electrodes (not shown). The lamps are spaced apart from each other by a predetermined interval to generate light in response to an externally provided power source. Each of the lamps 110, for example, has a rod shape. Alternatively, each of the lamps may have various shapes such as, for example a U-shape or an L-shape.

The receiving container 120 includes a bottom plate 122 and a plurality of sidewalls 124. The bottom plate 122, for example, has a rectangular plate shape. The sidewalls 124 are protruded from two edge portions of the bottom plate 122. The two edge portions are on opposite sides with respect to each other. The sidewalls 124 are integrally formed with the bottom plate 122. Throughholes 126 are formed on the bottom plate 122, and the supporting member 130 is combined with the bottom plate 122 through the throughholes 126. The receiving container 120 receives the lamps 110. In the present embodiment, the receiving container 120 receives twelve lamps 110, but the number of the lamps 110 is not limited to the above number. The receiving container 120 may include a metal so as to rapidly radiate heat generated from the lamps 110.

Referring to FIGS. 2 and 3, the supporting member 130 includes a base substrate 132, a plurality of lamp-fixing parts 134 and a plurality of combination parts 136.

The base substrate 132, for example, has a rectangular plate shape.

The lamp-fixing parts 134 are formed on an upper surface of the base substrate 132 to receive and fix the lamps 110. Each of the lamp-fixing parts 134, for example, has a loop shape. At least a portion of each lamp-fixing part 134 is open. In the present embodiment, four lamp-fixing parts 134 are formed on the upper surface of the base substrate 132. Alternatively, the number of the lamp-fixing parts 134 may be, for example, two or at least six. The number of the lamp-fixing parts 134 may preferably be even number. Alternatively, the number of the lamp-fixing parts 134 may be an odd number.

The combination parts 136 are formed on a lower surface of the base substrate 132. Each of the combination parts 136 is inserted through one of the throughholes 126, and slides in one direction to be combined with the bottom plate 122 of the receiving container 120.

Each of the combination parts 136 includes a first extension portion 136a, a second extension portion 136b and a combination protrusion 136c. The first extension portion 136a is downwardly extended from the lower surface of the base substrate 132. The second extension portion 136b is extended from the first extension portion 136a substantially in a parallel direction with the base substrate 132. The combination protrusion 136c is protruded from the second extension portion 136b toward the base substrate 132.

The second extension portion 136b is on a rear surface of the bottom plate 122 of the receiving container 120. Thus, a thickness T1 of the second extension portion 136b, with respect to a direction substantially perpendicular to the base substrate 132, affects the thickness of the backlight assembly 100 and a thickness of a liquid crystal display device (not shown) having the backlight assembly 100. Since the supporting member 130 is combined with the receiving container 120 using a slide method, the second extension portion 136b may have a flat and thin shape. The thickness T1 may be no more than about 3.0 mm. Preferably, the thickness T1 may be no more than about 1.2 mm. A conventional supporting member has a thickness of about 3.0 mm. Thus, the thickness of the backlight assembly 100 and the thickness of the LCD device having the backlight assembly 100 are smaller than that of a conventional backlight assembly and LCD device employing a conventional supporting member using a hook combination.

The combination protrusion 136c is protruded from an edge portion of the second extension portion 136b toward the base substrate 132. A combination groove 128 corresponding to the combination protrusion 136c is formed on the rear surface of the bottom plate 122 of the receiving container 120, so that the combination protrusion 136c is inserted into the combination groove 128. An end portion of the combination protrusion 136c may make contact with a portion of the rear surface of the bottom plate 122, more specifically, the portion corresponding to the combination groove 128.

The receiving container 120 has a slant portion between the combination groove 128 and the throughhole 126 such that the combination protrusion 136c slides from the throughhole 126 to the combination groove 128. Thus, the combination part 136 may be easily combined with the bottom plate 122 of the receiving container 120.

Hereinafter, a combination of the supporting member 130 and the receiving container 120 will be described in detail.

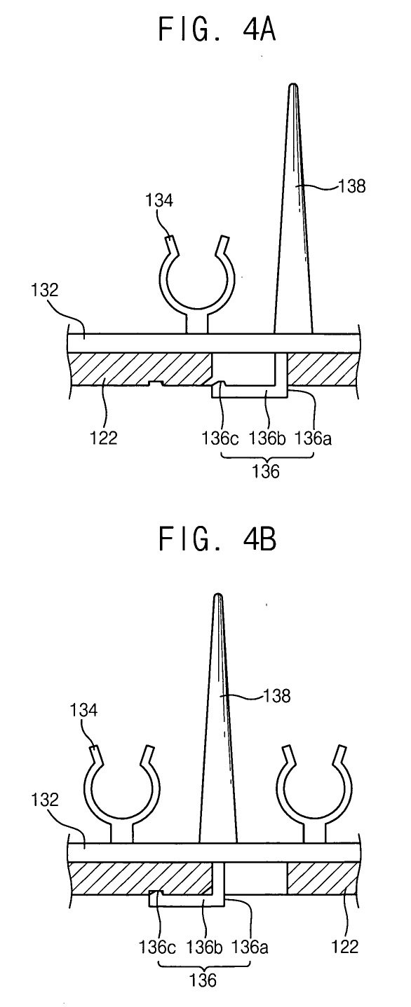

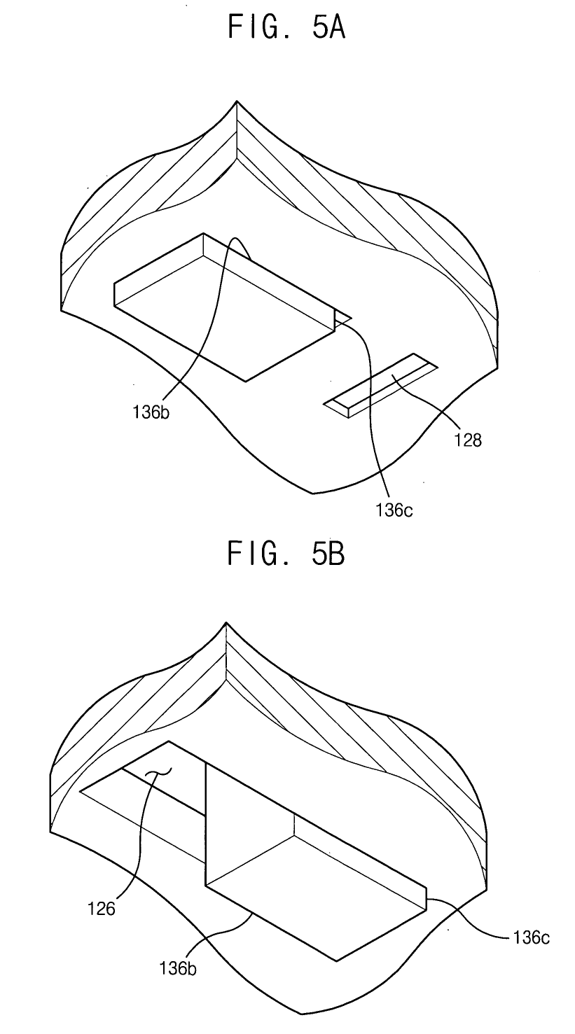

FIGS. 4A and 4B are partially cut-out front views illustrating a combination of a supporting member with a receiving container. FIGS. 5A and 5B are partially cut-out perspective views illustrating a combination of a supporting member with a receiving container.

Referring to FIGS. 4A through 5B, the combination part 136 that has the first and second extension portions 136a and 136b and the combination protrusion 136c is inserted through the throughhole 126 formed through the bottom plate 122 of the receiving container 120. The second extension portion 136b extends toward the combination groove 128 formed on the rear surface of the bottom plate 122. The throughhole 126 is large enough to receive the combination part 136.

After the combination part 136 is inserted through the throughhole 126, the supporting member 130 slides toward a direction in which the second extension portion 136b faces. The rear surface of the bottom plate 122 has a slant portion angled such that the combination protrusion 136c slides from the throughhole 126 to the combination groove 128.

Particularly, the rear surface of the bottom plate 122 of the receiving container 120 has a slant portion between the combination groove 128 and the throughhole 126. Thus, the combination protrusion 136c slides from the throughhole 126 to the combination groove 128. For example, the slant portion may be formed on an entire surface of the rear surface of the bottom plate 122. Alternatively, the slant portion may be formed only on a portion of the rear surface of the bottom plate 122, at which the combination protrusion 136c begins to slide. The slant portion may have a substantially uniform slant angle over the slant portion, that is, the slant portion may be linear. Alternatively, the slant portion may have a non-uniform slant angle, that is, the slant portion may be rounded.

When the combination protrusion 136c slides and thus is inserted into the combination groove 128, the supporting member 130 makes close contact with the receiving container 120 and is fixed to the receiving container 120. After the supporting member 130 is fixed to the receiving container 120, a tension is applied to the first extension portion 136a. Thus, the supporting member 130 may be firmly fastened to the receiving container 120, so that vibration of the supporting member 130 may be prevented. For example, the vibration of the supporting member 130 may correspond to a frequency of a speaker employed in an LCD device having the supporting member 130.

Referring again to FIGS. 1 to 3, the supporting member 130 may further includes a supporting part 138. The supporting part 138 is formed on the base substrate 132, and formed between the lamp-fixing parts 134. The supporting part 138, for example, has a cone shape, and supports an optical member (not shown) disposed over the supporting member 130.

In the present embodiment, a plurality of supporting members 130 is arranged in a zigzag shape. Thus, the optical member may be effectively disposed over the supporting members 130, so that sagging of the optical member is prevented. Alternatively, the supporting members 130 may be linearly arranged, and thus at least two supporting members 130 may be disposed for each set of the lamps 110 so as to prevent the sagging of the optical member. The set of the lamps 110 is a group of the lamps that are received and supported by one supporting member 130.

The supporting member 130, for example, includes a material having a good elasticity. Thus, although a width of an open portion of each lamp-fixing part 134 of the supporting member 130 is smaller than a diameter of each lamp 110, the lamp 110 may be easily combined with the lamp-fixing part 134 of the supporting member 130. Since the supporting member 130 is disposed adjacent to the lamp 110, the supporting member 130 may preferably include a material having a good heat-resistance. The supporting member 130 may include a transparent material so as not to block light generated from the lamp 110.

The backlight assembly 100 may further include a side mold 140. The side mold 140 is disposed on edge portions of the bottom plate 122. The side mold 140 receives and fixes end portions of each lamp 110. A lamp wire (not shown) is electrically connected to the lamp 110 through an outer surface of the side mold 140. The lamp wire is electrically connected to an inverter (not shown) for applying a power source to the lamp 110. Thus, the power source is applied to an electrode of the lamp 110, and thus the lamp 110 is operated. The side mold 140 may include a step portion on which an edge portion of the optical member is disposed.

The backlight assembly 100 optionally includes a reflective sheet (not shown) between the receiving container 120 and the base substrate 132 of the supporting member 130. An insertion hole (not shown) is formed through the reflective sheet such that the combination part 136 of the supporting member 130 is inserted through the insertion hole. The insertion hole corresponds to the throughhole 126 of the receiving container 120. The reflective sheet reflects a portion of light toward the optical member. The portion of light reflected is the light generated from the lamp 110 toward the receiving container 120.

According to the present embodiment, the supporting member 130 is combined with the receiving container 120 using the slide method, so that a gap is not formed between the supporting member and the receiving container. Thus, impurities may not flow into a space between the supporting member 130 and the receiving container 120. In addition, a rattle noise of the supporting member 130 may be prevented. The rattle noise may be due to, for example, vibration corresponding to a frequency of a speaker employed in an LCD device having the supporting member 130. Leakage of light that is generated from the lamp 110 may be also prevented. Furthermore, drift of the supporting member 130 may be prevented, and a secure combination of the supporting member 130 with the receiving container 120 may be easily verified. A thickness of the supporting member 130 externally protruded from the receiving container 120 may be reduced, so that a thickness of the backlight assembly 100 having the supporting member 130 may be also reduced.

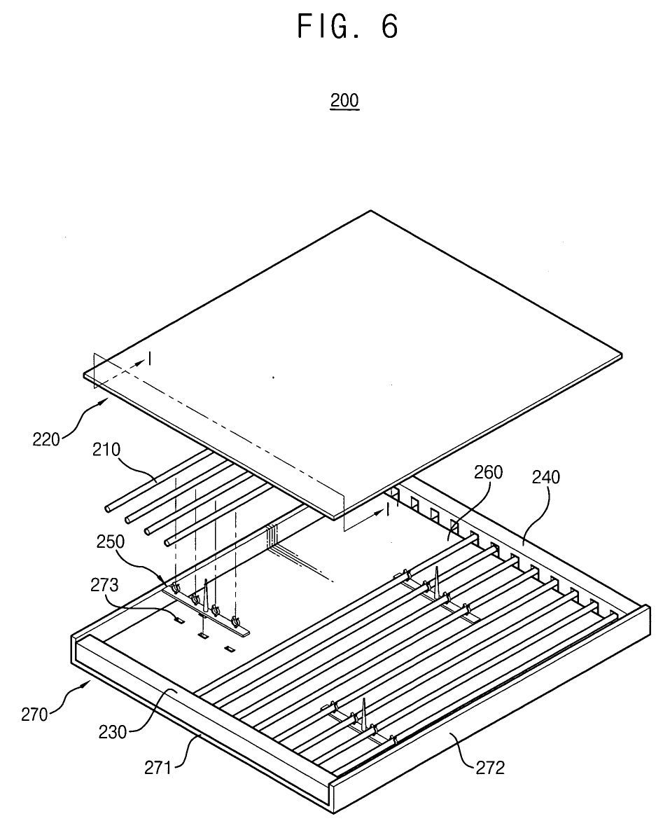

FIG. 6 is an exploded perspective view illustrating a backlight assembly according to an embodiment of the present invention.

The backlight assembly 200 includes a plurality of lamps 210 generating light, a light-diffusing plate 220 diffusing the light, first and second side molds 230 and 240 fixing the lamps 210, a supporting member 250 preventing the light-diffusing plate 220 from sagging, a reflective sheet 260 reflecting the light from the lamps 210, and a receiving container 270.

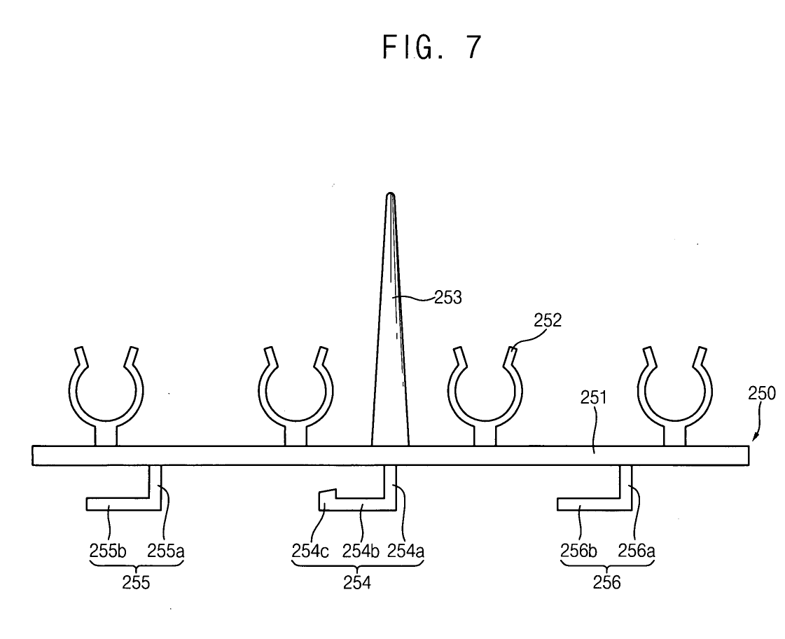

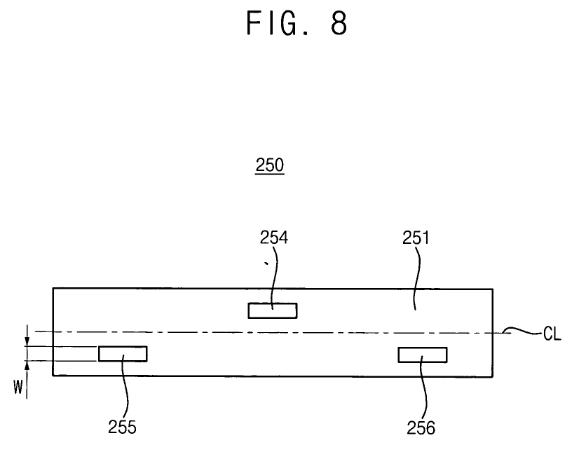

The backlight assembly 200 is substantially identical to the backlight assembly 100 described in connection with FIG. 1 except for the supporting member 250. FIG. 7 is a front view illustrating a supporting member shown in FIG. 6. FIG. 8 is a bottom view illustrating a supporting member shown in FIG. 6.

Referring to FIGS. 6 to 8, the supporting member 250 includes a base substrate 251, a plurality of lamp-fixing parts 252, a supporting part 253 and a plurality of combination parts 254, 255 and 256. Each of the lamp-fixing parts 252 is protruded from an upper surface of the base substrate 251 to be combined with the lamps 210. The supporting part 253 is protruded from the upper surface of the base substrate 251 to support the light-diffusing plate 220. Each of the combination parts 254, 255 and 256 is protruded from a lower surface of the base substrate 251 to be combined with the receiving container 270

A longitudinal direction of the base substrate 251 is substantially perpendicular to a longitudinal direction of each lamp 210.

The lamp-fixing parts 252 fix the positions of the lamps 210. In the present embodiment, the supporting member 250 includes four lamp-fixing parts 252. Two supporting members 250 are spaced apart from another two supporting members 250 with respect to the position of the supporting parts 253. The number of the lamp-fixing parts 252 may increase or decrease in accordance with a size of the base substrate 251.

The supporting part 253 supports the light-diffusing plate 220, so that a distance between the light-diffusing plate 220 and the lamps 210 is substantially constant.

The combination parts 254, 255 and 256 are disposed on the lower surface of the base substrate 251 that is different from surface on which the lamp-fixing parts 252 and the supporting part 253 are disposed.

As shown in FIG. 8, the combination parts 254, 255 and 256 are named as a first combination part 254, a second combination part 255 and a third combination part 256, respectively. The first, second and third combination parts 254, 255 and 256 are spaced apart from each other by a predetermined distance.

Referring to FIG. 8, the first, second and third combination parts 254, 255 and 256 are arranged in a zigzag shape. In other words, the first combination part 254 is spaced apart from the second and third combination parts 255 and 256 with respect to a longitudinal central line CL of the base substrate 251. Thus, drifting of the first, second and third combination parts 254, 255 and 256 in a direction substantially in parallel with a bottom plate 271 of the receiving container 270, that is, in a longitudinal direction of the lamps 210, is prevented. Hence, a rattle noise of the supporting member 250 may be prevented. The rattle noise is due to, for example, vibration corresponding to a frequency of a speaker employed in an LCD device having the supporting member 250.

The first, second and third combination parts 254, 255 and 256 have substantially the same width ‘W’. For example, the width ‘W’ is about 4 mm. The first, second and third combination parts 254, 255 and 256 are arranged in a zigzag shape as described above, so that the drift of the supporting member 250 may be prevented even though the width ‘W’ is reduced.

When the width of the first, second and third combination parts 254, 255 and 256 decreases, a size of each throughhole 273 of the receiving container 270 also decreases. Thus, leakage of light through the receiving container 270 may be reduced.

Referring again to FIG. 7, the first, second and third combination parts 254, 255 and 256 include first extension portions 254a, 255a and 256a, and second extension portions 254b, 255b and 256b, respectively. The first extension portions 254a, 255a and 256a are protruded from the lower surface of the base substrate 251. The second extension portions 254b, 255b and 256b are extended from end portions of the first extension portions 254a, 255a and 256a, respectively. The second extension portions 254b, 255b and 256b extend parallel to the base substrate 251.

The first combination part 254 further includes a combination protrusion 254c protruded from an end portion of the second extension portion 254b toward the base substrate 251. In the present embodiment, although the first combination part 254 only includes the combination protrusion 254c, the second and third combination parts 255 and 256 may include a combination protrusion so as to more firmly combine the supporting member 250 with the receiving container 270.

Hereinafter, a combination of the supporting member 250 with the receiving container 270 will be described in detail.

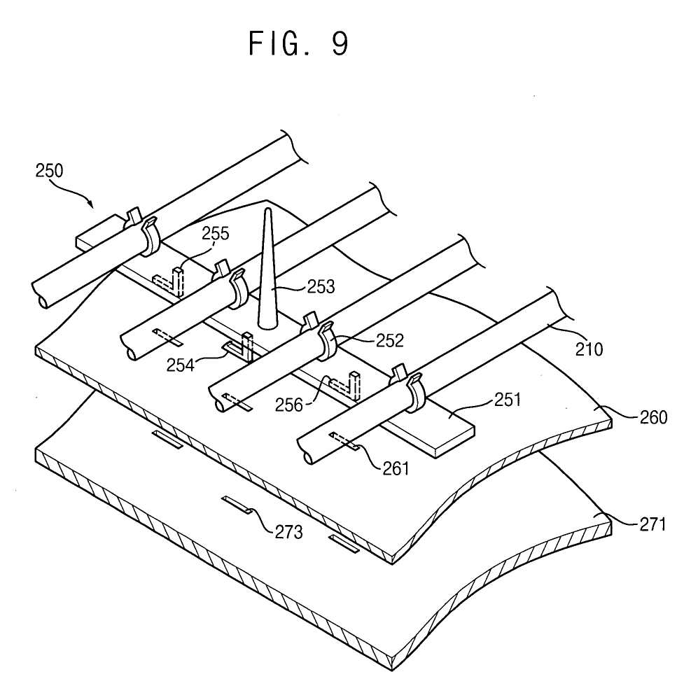

FIG. 9 is a partially cut-out exploded perspective view illustrating a combination of a supporting member with lamps, a reflective sheet and a receiving container.

Referring to FIG. 9, a lamp is inserted into the lamp-fixing part 252 of the supporting member 250.

The reflective sheet 260 has a plurality of insertion holes 261 corresponding to the first, second and third combination parts 254, 255 and 256. The supporting member 250 and the reflective sheet 260 are received in the receiving container 270. A plurality of throughholes 273 corresponding to the insertion holes 261 is formed through the bottom plate 271 of the receiving container 270.

The first, second and third combination parts 254, 255 and 256 of the supporting member 250 are combined with the bottom plate 271 of the receiving container 270 through the insertion holes 261 and the throughholes 273.

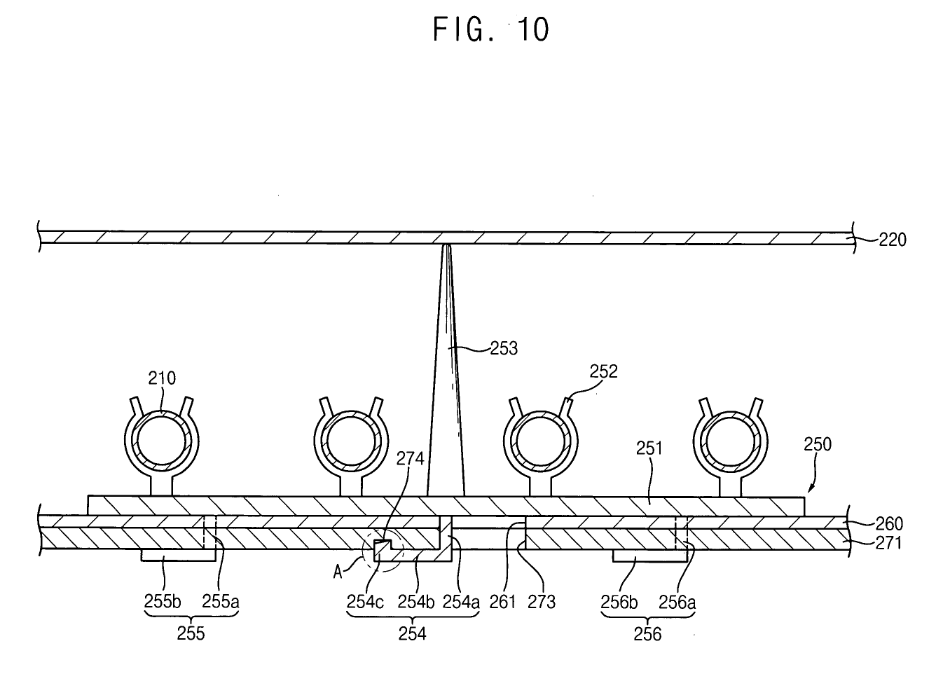

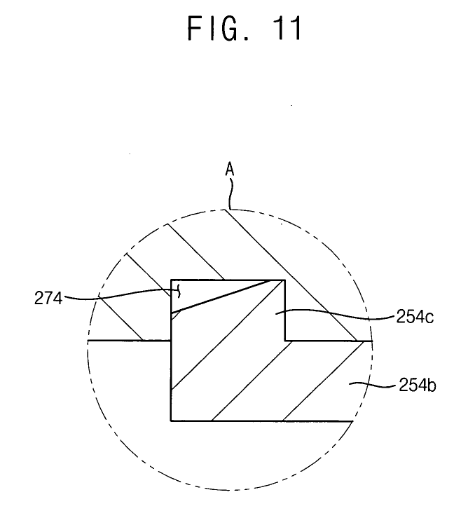

FIG. 10 is a cross-sectional view taken along a line I-I′ in FIG. 6. FIG. 11 is an enlarged cross-sectional view illustrating a portion ‘A’ in FIG. 10.

Referring to FIGS. 10 and 11, the base substrate 251 of the supporting member 250 is disposed on the reflective sheet 260. The lamps 210 are inserted into the lamp-fixing parts 252 of the supporting member 250 and fixed to the supporting member 250.

The supporting part 253 supports the light-diffusing plate 220 disposed over the lamps 210, and maintains a substantially uniform distance between the lamps 210 and the light-diffusing plate 220.

The first, second and third combination parts 254, 255 and 256 are combined with the bottom plate 271 of the receiving container 270 through the insertion holes 261 that are formed through the reflective sheet 260, and the throughholes 273 that are formed through the bottom plate 271.

Particularly, the first extension portion 254a of the first combination part 254 is inserted through the insertion hole 261 and the throughhole 273 corresponding to the first combination part 254. The second extension portion 254b of the first combination part 254 passes through the insertion hole 261 and the throughhole 273 corresponding to the first combination part 254, and then slides in one direction along the bottom plate 271 of the receiving container 270, so that the second extension portion 254b supports the bottom plate 271.

The bottom plate 271 of the receiving container 270 has a combination groove 274 corresponding to the combination protrusion 254c. The combination groove 274 is spaced apart from the throughhole 273 through which the first combination part 254 is inserted, by a predetermined distance.

As shown in FIG. 11, the combination protrusion 254c is inserted into the combination groove 274 to fasten the supporting member 250 to the receiving container 270.

Referring again to FIG. 10, the first extension portion 255a of the second combination part 255 is inserted through the insertion hole 261 and the throughhole 273 corresponding to the second combination part 255, and the first extension portion 256a of the third combination part 256 is inserted through the insertion hole 261 and the throughhole 273 corresponding to the third combination part 256.

The second extension portion 255b of the second combination part 255 passes through the insertion hole 261 and the throughhole 273 corresponding to the second combination part 255, and then slides in one direction along the bottom plate 271 of the receiving container 270, so that the second extension portion 255b supports the bottom plate 271. The second extension portion 256b of the third combination part 256 passes through the insertion hole 261 and the throughhole 273 corresponding to the third combination part 256, and then slides in one direction along the bottom plate 271 of the receiving container 270, so that the second extension portion 256b supports the bottom plate 271.

A combination of the supporting member 250 with the receiving container 270 is substantially the same as the combination described in connection with FIGS. 4A-5B.

According to the above, the first, second and third combination parts 254, 255 and 256 are combined with the receiving container 270 using a slide method, so that a gap is not formed at a combination portion. Thus, leakage of light through the receiving container 270 may be reduced.

According to the present embodiment, the first, second and third combination parts 254, 255 and 256 are arranged in a zigzag shape, so that the supporting member 250 is prevented from drifting in a longitudinal direction of the lamps 210. Thus, noise from rattling of the supporting member 250 may be prevented.

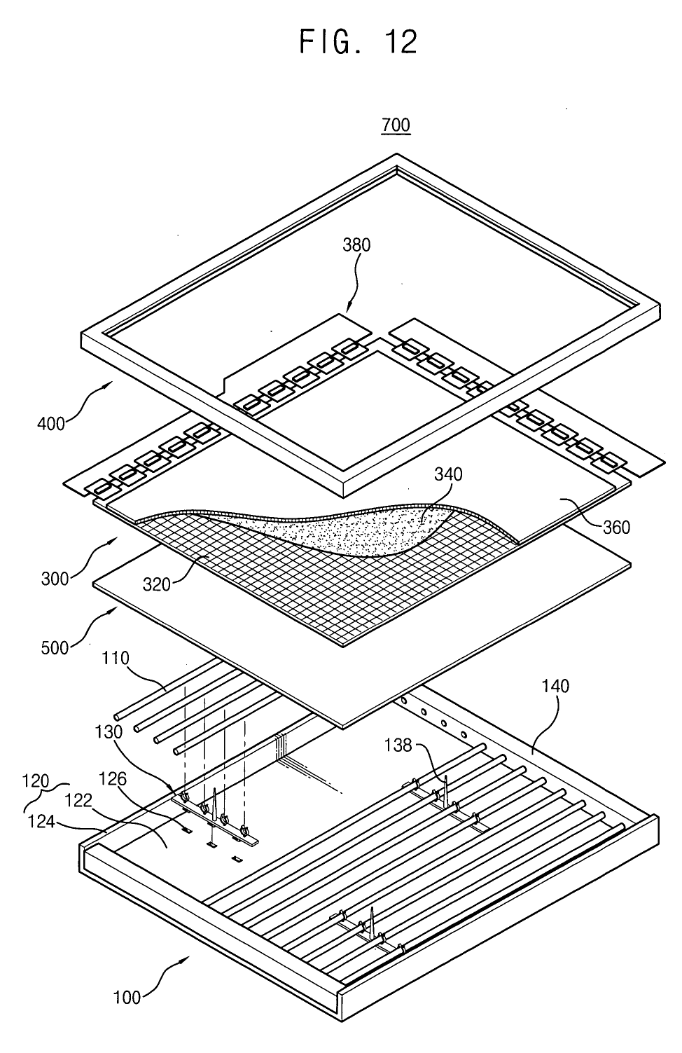

FIG. 12 is an exploded perspective view illustrating a liquid crystal display device according to an embodiment of the present invention.

Referring to FIG. 12, a liquid crystal display device (LCD) 700 includes a backlight assembly 100, an LCD panel 300 and a chassis 400.

The backlight assembly 100 according to the present embodiment has a substantially the same structure and function as the backlight assembly described in connection with FIG. 1.

The LCD panel 300 displays an image using light from the backlight assembly 100. The LCD panel 300 includes a thin film transistor (TFT) substrate 320, a liquid crystal layer 340, a color filter substrate 360 and a driving module 380.

The TFT substrate 320 includes pixel electrodes (not shown) arranged in a matrix shape, TFTs (not shown) applying a driving voltage to the pixel electrode, gate lines (not shown) and data lines (not shown).

The color filter substrate 360 includes color filters (not shown) facing the pixel electrodes formed on the TFT substrate 320, and a common electrode (not shown) formed on the color filters.

The liquid crystal layer 340 is disposed between the TFT substrate 320 and the color filter substrate 360.

The driving module 380 drives the LCD panel 300.

The chassis 400 surrounds edge portions of the color filter substrate 360, and is combined with a receiving container 120. The chassis 400 prevents the LCD panel 300 that is weak from being broken due to, for example, external impact. The chassis 400 also prevents drift of the LCD panel 300.

The LCD device 700 optionally includes an optical member 500 improving optical characteristics of light from the backlight assembly 100. The optical member 500, for example, includes a light-diffusing sheet, a prism sheet, or a protective sheet. A supporting part 138 of each supporting member 130 having a cone shape supports the optical member 500 positioned over the supporting member 130. In the present embodiment, the supporting members 130 are arranged in a zigzag shape to support the optical member 500, so that the supporting members 130 prevent the optical member 500 from sagging.

The LCD device 700 may include a middle chassis (not shown) over the optical member 500. The middle chassis makes contact with the optical member 500 and presses the optical member 500 toward the receiving container 120.

The LCD device 700 includes the backlight assembly 100 shown in FIG. 1. Alternatively, the LCD device 700 may include the backlight assembly 200 shown in FIG. 6.

According to the present embodiment, the supporting member 130 is combined with the receiving container 120 using a slide method, so that a gap is not formed at a combination portion and a thickness of the supporting member 130 externally protruded from the receiving container 120 is reduced. Thus, the LCD device 700 has an enhanced performance, and becomes more compact.

According to the embodiments of the present invention, a supporting member is combined with a receiving container using a slide method, so that a gap is not formed at a combination portion. Thus, impurities may not flow into a space between the supporting member and the receiving container, and a rattle noise of the supporting member may be prevented. The rattle noise may be due to, for example, vibration corresponding to a frequency of a speaker employed in an LCD device having the supporting member. In addition, leakage of light that is generated from a lamp employed in a backlight assembly having the supporting member may also be prevented.

In addition, the drift of the supporting member may be prevented. The drift may occur in a defective combination. Further, a secure combination of the supporting member with the receiving container may be easily verified.

Furthermore, a thickness of the supporting member externally protruded from the receiving container is reduced, so that a thickness of the backlight assembly having the supporting member is also reduced.

As a result, an LCD device including the backlight assembly may have improved optical characteristics, and become more compact.

Although the exemplary embodiments of the present invention have been described herein with reference to the accompanying drawings, it is to be understood that the present invention should not be limited to these exemplary embodiments but various changes and modifications can be made by one ordinary skilled in the art within the spirit and scope of the present invention. All such changes and modifications are intended to be included within the scope of the invention as defined by the appended claims.

What is claimed is:

1. A supporting member for a display device, the supporting member supporting at least one lamp and comprising:
a base;
a lamp-fixing part formed on an upper surface of the base to fix the lamp; and
a combination part formed on a lower surface of the base, wherein the combination part is inserted through a hole in a receiving container, and slides in a direction to combine with a plate of the receiving container.

2. The supporting member of claim 1, wherein the combination part comprises:
a first extension portion downwardly extended from the lower surface of the base;
a second extension portion extended from the first extension portion in a direction substantially in parallel with the base; and
a protrusion protruded from the second extension portion toward the base.

3. The supporting member of claim 1, further comprising a supporting part configured to support an optical member disposed over the supporting member.

4. The supporting member of claim 1, further comprising a plurality of combination parts, wherein the combination parts are spaced apart from each other with respect to a longitudinal central line of the base.

5. A supporting member for a display device comprising:
a base;
a lamp-fixing part protruded from the base in a first direction to fix at least one lamp;
a supporting part protruded from the base in the first direction to support an optical member; and
at least two combination parts protruded from the base in a second direction opposite the first direction, the combination parts being spaced apart from each other with respect to a longitudinal central line of the base.

6. The supporting member of claim 5, wherein the combination parts are arranged in a zigzag configuration.

7. The supporting member of claim 5, wherein each of the combination parts comprises:
a first extension portion protruded from the base; and
a second extension portion extended from the first extension portion in a direction substantially parallel to the base.

8. The supporting member of claim 7, wherein at least one of the combination parts further comprises a protrusion protruded from the second extension portion toward the base.

9. The supporting member of claim 5, wherein each of the combination parts has a width less than or equal to about 4 mm.

10. The supporting member of claim 5, wherein each of the combination parts is inserted through a hole of a receiving container for a display device and slides in a direction to combine with a bottom plate of the receiving container.

11. A backlight assembly comprising:
a lamp;
a receiving container configured to receive the lamp, the receiving container including a bottom plate through which a hole is formed; and
a supporting member comprising:
a base;
a lamp-fixing part formed on an upper surface of the base to fix the lamp; and
a combination part formed on a lower surface of the base, the combination part being inserted through the hole and sliding in a direction to combine with a bottom plate of the receiving container.

12. The backlight assembly of claim 11, wherein the lamp-fixing part has a loop shape, and at least a portion of the lamp-fixing part is open.

13. The backlight assembly of claim 11, wherein the combination part comprises:
a first extension portion downwardly extended from the lower surface of the base;
a second extension portion extended from the first extension portion in a direction substantially in parallel with the base; and
a protrusion protruded from the second extension portion toward the base.

14. The backlight assembly of claim 13, wherein the second extension portion has a thickness of less than or equal to about 3.0 mm with respect to a direction substantially perpendicular to the base.

15. The backlight assembly of claim 14, wherein the receiving container further comprises a groove formed on the bottom plate, and the groove receives the protrusion.

16. The backlight assembly of claim 15, wherein the receiving container has a slant portion between the hole and the groove such that the protrusion slides through the hole to the groove.

17. The backlight assembly of claim 11, wherein the supporting member further comprises a supporting part configured to support an optical member disposed over the supporting member.

18. The backlight assembly of claim 11, further comprising a side mold configured to hold an end portion of the lamp and fix the lamp.

19. The backlight assembly of claim 11, further comprising a reflective sheet between the receiving container and the base of the supporting member.

20. The backlight assembly of claim 11, wherein the supporting member further comprises a plurality of combination parts, and wherein the combination parts are spaced apart from each other with respect to a longitudinal central line of the base.

21. The backlight assembly of claim 11, wherein the combination parts are arranged in a zigzag shape.

22. A display device comprising:
a backlight assembly comprising:
a lamp;
a receiving container configured to receive the lamp, the receiving container including a bottom plate through which a hole is formed; and
a supporting member comprising a base, a lamp-fixing part formed on an upper surface of the base to fix the lamp and a combination part formed on a lower surface of the base, the combination part being inserted through the hole and sliding in a direction to combine with a bottom plate of the receiving container; and
a display panel configured to display an image using light from the lamp of the backlight assembly.

23. The display device of claim 22, further comprising an optical member disposed between the backlight assembly and the display panel.

24. A display device comprising:
a display panel configured to display an image using light;
a lamp configured to generate the light;
an optical member configured to alter optical characteristics of the light from the lamp;
a receiving container configured to receive the lamp and having a hole; and
a supporting member comprising:
a base;
a lamp-fixing part protruded from the base to fix at least one lamp generating the light;
a supporting part protruded from the base to support the optical member; and
at least two combination parts protruded from the base to be combined with the receiving container, the combination parts being spaced apart from each other with respect to a longitudinal central line of the base.

25. The display device of claim 24, wherein each of the combination parts comprises:
a first extension portion protruded from the base and inserted through the hole; and
a second extension portion extended from the first extension portion, the second extension portion sliding in a direction substantially in parallel with the base to combine with the receiving container.

26. The display device of claim 25, wherein the second extension portion supports a bottom plate of the receiving container.

27. The display device of claim 25, wherein the receiving container further comprises a groove, and the combination part further comprises a protrusion protruded from the second extension part to be inserted into the groove.

28. The display device of claim 24, further comprising a reflective sheet received in the receiving container to reflect the light from the lamp toward the optical member, the reflective sheet having a hole corresponding to the hole in the receiving container.

29. The display device of claim 28, wherein the base is disposed on the reflective sheet.
